(19) United States
(12) Patent Application Publication
(10) Pub. No.: US 2007/0235902 A1
(43) Pub. Date: Oct. 11, 2007

(54) MICROSTRUCTURED TOOL AND METHOD OF MAKING SAME USING LASER ABLATION

(75) Inventors: Patrick R. Fleming, Lake Elmo, MN (US); Paul E. Humpal, Stillwater, MN (US); Thomas R.J. Corrigan, St. Paul, MN (US); Todd R. Williams, Lake Elmo, MN (US); Tadesse G. Nigatu, Maplewood, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/278,278

(22) Filed: Mar. 31, 2006

(51) Int. Cl. B21D 39/00; B32B 15/01; B29C 71/00; B29C 41/42; B23K 26/36

(52) U.S. Cl. 264/400; 428/624; 428/680; 428/469; 428/432; 428/457; 264/236; 264/237; 264/334

(57) ABSTRACT

Disclosed herein is a microstructured tool having a microstructured layer having a polymer and a microstructured surface; a nickel layer disposed adjacent the microstructured layer opposite the microstructured surface; and a base layer disposed adjacent the nickel layer opposite the microstructured layer. The microstructured surface may have at least one feature having a maximum depth of up to about 1000 um. Also disclosed herein is a method of making the microstructured tool using laser ablation. The microstructured tool may be used to make articles suitable for use in optical applications.

### CROSS REFERENCE TO RELATED APPLICATION

This application is related to commonly assigned, co-pending U.S. patent application Ser. No. ______ by Humpal et al., entitled “Microstructured Tool and Method of Making Using Laser Ablation”, and filed of even date herewith (Docket 61177US002).

### FIELD OF THE INVENTION

The invention relates to a microstructured tool and particularly to a microstructured tool comprising a nickel layer between a base layer and a microstructured layer. The microstructured tool is made using laser ablation.

### BACKGROUND

Microstructured tools comprising features of less than several millimeters are used in replication processes for forming microstructured replicas able to perform a specific function. The replicas can be made directly from a microstructured tool or from a metal tool which is formed from the microstructured tool. Microstructured replicas are used in a variety of applications including optical applications in which they function as prisms, lenses, and the like. In such applications, it is often critical that these microoptical components, and therefore the microstructured tools from which they are made, be free of imperfections such as surface roughness that might otherwise produce undesirable optical artifacts.

Laser ablation is a process that may be used to form microstructured tools having a microstructured polymer layer on a supporting substrate. The microstructured polymer layer comprises a polymer layer having one or more recessive features on its surface which are formed by removal of polymer in selected regions. Removal of polymer is a result of decomposition following absorption of radiation from a laser. In order to meet the growing demand for microoptical components, it is desirable to use laser ablation to form microstructured tools that meet the stringent criteria described above. Thus, there is a need for new materials that may be used in laser ablation processes.

### SUMMARY

Disclosed herein is a microstructured tool comprising a microstructured layer comprising a polymer and having a microstructured surface, the microstructured surface comprising one or more features; a nickel layer comprising nickel and disposed adjacent to the microstructured layer opposite the microstructured surface, and a base layer comprising metal, polymer, ceramic, or glass, the base layer disposed adjacent to the nickel layer opposite the microstructured layer.

Also disclosed herein is a method of making the microstructured tool using laser ablation. The method comprises providing a laser ablatable article comprising a laser ablatable layer comprising a polymer, a nickel layer comprising nickel and disposed adjacent the laser ablatable layer, and a base layer comprising metal, polymer, ceramic, or glass, the base layer disposed adjacent to the nickel layer opposite the laser ablatable layer; providing a laser ablation apparatus having a laser; and ablating the laser ablatable layer with radiation from the laser to form a microstructured surface comprising one or more features.

The microstructured tool disclosed herein may be used to make microstructured replicas. One method for making such microstructured replicas comprises providing the microstructured tool, applying a liquid composition over the microstructured surface, hardening the liquid composition to form a hardened layer, and separating the hardened layer from the microstructured tool. The microstructured tool disclosed herein may also be used to make microstructured metal tools. One method for making such microstructured metal tools comprises providing the microstructured tool, applying a metal over the microstructured surface to form a metal layer and then separating the two layers. The metal layer becomes the microstructured metal tool from which microstructured replicas may be made.

The microstructured articles disclosed herein may be used in optical applications such as plasma display devices, computer monitors, and hand-held devices; channel structures in microfluidic chips; mechanical applications, etc.

The above summary is not intended to describe each disclosed embodiment or every implementation of the invention. The Figures and the detailed description which follow more particularly exemplify illustrative embodiments.

### BRIEF DESCRIPTION OF THE DRAWINGS

FIGS. 1-2b show cross-sectional views of exemplary microstructured tools.

FIGS. 3a-3d show cross-sectional views of exemplary microstructured surfaces.

FIG. 4a is a photograph of a base layer after laser ablation.

FIG. 4b is a photograph of a nickel layer after laser ablation.

FIGS. 5a are 5b are photographs of a microstructured tool.

FIG. 6 is a photograph of an exemplary microstructured metal tool.

### DETAILED DESCRIPTION

As described above, laser ablation is a process that may be used to create a microstructured polymer layer on a supporting substrate. In this process, radiation is emitted by the laser such that it is incident upon selected areas of the polymer layer. The polymer layer absorbs the radiation and removal of polymer occurs by vaporization due to some combination of photothermal and photochemical mechanisms. The combination typically depends on selected properties of the polymer, for example, melting point, absorption coefficient at the wavelength of the radiation, heat capacity, and refractive index, and on laser ablation conditions such as laser fluence, wavelength, and pulse duration.

Microstructured tools suitable for use in optical applications, as disclosed herein, may be made using multi-shot laser ablation processes in which more than one shot by the laser is used to form each feature. This process allows one to control the side wall angles of the features and also to remove polymer down to the surface of the substrate or down to the surface of the nickel layer. Multi-shot laser ablation is also used for microstructuring thick polymer layers, for example, greater than 15 um.

Many types of systems are available for use in multi-shot laser ablation processes including, for example, projection, spot writing, shadow masking, and holographic systems. In a shadow masking ablation system, for example, a mask having the desired pattern is placed in close proximity or in contact with a laser ablatable article having a polymer layer. The pattern is formed on the surface of the polymer layer because the mask allows radiation to reach only selected areas. Laser ablation systems preferably utilize lasers that emit radiation having a wavelength of 400 nm or less including, for example, excimer lasers such as KrF, F₂, ArF, KrCl, XeF, or XeCl lasers, or lasers that emit radiation having longer wavelengths but are converted to 400 nm or less using nonlinear crystals. Useful laser ablation systems and methods are described, for example, in U.S. Pat. No. 6,285,001 B1.

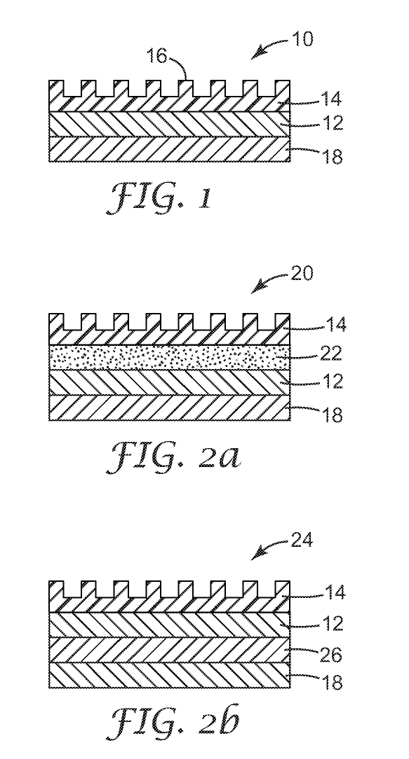

The microstructured tool 10 disclosed herein, as shown in the example of FIG. 1, comprises microstructured layer 14 comprising a polymer, the microstructured layer having a microstructured surface 16; nickel layer 12 comprising nickel, the nickel layer disposed adjacent the microstructured layer opposite the microstructured surface; and a base layer 18 disposed adjacent the nickel layer opposite the microstructured layer.

The particular material used as the base layer will depend upon the particular application, but in general, the material should be lightweight, durable, inexpensive, and compatible with the nickel layer. The base layer is also desirably stable under ordinary laboratory storage conditions with respect to temperature, humidity and light, and towards any materials in which it may come in contact with such as cleaning solutions, the polymer of the microstructured layer, and the material used to form the microstructured replicas.

The base layer may comprise metal, polymer, ceramic, or glass. Suitable materials include metals such as aluminum and its alloys, steel and its alloys, especially stainless steel, copper, brass, or tin; polymers such as polycarbonates, polyimides, polyesters, polystyrenes, or poly(meth)acrylics; ceramics such as silicon, alumina, and silicon nitride; glasses such as fused silica, optical glass, or float glass, or composites containing fiberglass. The base layer may also comprise nickel such that the nickel layer and the base layer are one and the same. Preferably, the base layer comprises aluminum because aluminum is inexpensive, doesn't shatter, and is readily available in a variety of areas and thicknesses.

The surface roughness of the base layer, for the side adjacent the nickel layer, may be important in obtaining desirable microstructured tools and replicas. If the nickel layer is a conformal coating on the base layer, then the base layer must have a roughness that is at least as good as that needed at the top of microstructured replicas that will be made from the microstructured tool having the base layer. On the other hand, if the nickel layer is not a conformal coating and can fill in any irregularities on the base layer, then the roughness of the base layer may be greater than what is desired in the microstructured tool and article.

The thickness of the base layer will also depend on the particular application, as well as on the nature of the material being used. In general, the base layer should be thick enough to be handleable, self-supporting and resistant to damage such as cracking, kinking, and breaking under routine handling. The stiffness of the base layer is not particularly limited but, in general, the larger the area, the more desirable it is to have a stiffer base layer. For stiffness and handleability, the microstructured tool may have a product of the modulus of elasticity times the thickness cubed of at least about 0.005 N-m (0.05 in-lb). For example, a base layer comprising 51 um (2 mil) thick aluminum (modulus 71×10⁹ N/m² (10.3×10⁶ lb/in²)) may be useful because the product of the modulus of elasticity times the thickness cubed is about 0.009 N-m (0.08 in-lb). Aluminum having a thickness of up to 254 um (10 mil) may also be useful. For another example, a base layer comprising 6.4 mm (250 mil) thick steel (modulus 207×10⁹ N/m² (30×10⁶ lb/in²)) may be useful because the product is about 54264 N-m (468750 lb-in).

In some cases, such as in the manufacture of barrier ribs used in plasma display devices, it is desirable for the base layer to have a sufficiently large area, for example, greater than about 100 cm² or greater than about 1000 cm². If the base layer is thick enough to have a measurable flatness, it may be desirable to have a flatness of better than about 10 μm per 100 cm² or better than about 10 μm per 1000 cm². If the base layer is too thin to have a measurable flatness, and it is supported during ablation by another flat object such as a support table or vacuum table, then it may be desirable for the base layer to have a parallelism of better than about 10 μm per 100 cm² or better than about 10 μm per 1000 cm².

In general, the nickel layer acts as a stop layer to the laser light used to form the microstructured surface 16 of the microstructured layer as shown in FIG. 1. The nickel layer comprises nickel and may be a layer of a nickel-based alloy, or it may consist essentially of nickel, i.e., it may be a layer of solid nickel. The nickel layer is also desirably stable under ordinary laboratory storage conditions with respect to temperature, humidity and light, and towards any materials in which it may come in contact with such as cleaning solutions, the polymer, and the material used to form the microstructured replicas. The nickel layer may be formed on the base layer by electrochemical processes, sputtering, chemical vapor deposition, or physical vapor deposition. Combinations of these methods may also be used. Optionally, a construction comprising the nickel layer and the laser ablatable layer may be laminated to the base layer.

The surface of the nickel layer 12 which is adjacent microstructured layer 14, referred to herein as the first surface, must have a roughness that is at least as good as that needed at the top of microstructured replicas that will be made from a microstructured tool having the nickel layer. In general, this surface of the nickel layer may have an arithmetical mean roughness (Ra) of 1 um or less, and for most optical applications, Ra is 100 nm or less. The roughness of the first surface after ablation should be no more than these limits as well.

The thickness of the nickel layer will also depend on the particular application, and in general, it should be thick enough such that it can tolerate, without detectable damage, at least four times more light intensity than it takes to ablate completely the laser ablatable layer. Useful thicknesses are at least about 0.5 um, for example, from about 0.5 um to about 2 cm.

The laser ablatable layer, i.e., the microstructured layer before it is ablated, and the microstructured layer itself, comprises a polymer. Suitable polymers include, for example, polycarbonate, polystyrene, polyurethane, polysulfone, polyimide, polyamide, polyester, polyether, phenolic, epoxy, (meth)acrylics, or combinations thereof.

The particular choice of polymer may be influenced by a variety of factors. For one, the polymer should be selected such that the laser ablatable layer and the microstructured layer are stable under laboratory storage conditions with respect to temperature, humidity and light, and towards any materials in which they may come in contact with such as cleaning solutions, the nickel layer, release agents, and the material used to form the microstructured replicas. Also, as described below, the polymer ideally has an absorption coefficient greater than about 1×10³ per cm at the wavelength of the radiation provided by the laser.

The laser ablatable layer may be provided in a number of ways. For example, the laser ablatable layer may be provided in the form of a film onto which the nickel layer is applied, or the two may be laminated together. Alternatively, the laser ablatable layer may be prepared by casting a layer of molten polymer on the nickel layer which is then cooled and hardened, and then optionally cured to form the layer. Another option is to cast a solution comprising one or more monomers, oligomers, and/or polymers on the nickel layer which are then subsequently cured to form the layer. Examples of suitable polymers are described in commonly assigned, co-pending U.S. patent application Ser. No. ______ by Humpal et al., entitled “Microstructured Tool and Method of Making Using Laser Ablation”, and filed of even date herewith (Docket 61177US002); the disclosure of which is incorporated herein by reference for all that it contains. Preferably, the laser ablatable layer is crosslinked to minimize reflow in an ablated region.

Common curing processes include heat, time, and radiation such as UV radiation and electron beam radiation. Before curing, care must be taken so that the coated material to be cured does not flow and cause variations in the coating thickness. UV radiation is preferred and UV curable monomers, oligomers and/or polymers are preferred because they cure quickly, reducing the amount of time for the coated material to shift, and also because they cure at or near room temperature, reducing the possibility of stress as described below. UV radiation in combination with heating may also be employed.

Other components which may be included in the polymer layer include dyes, UV absorbers, plasticizers, and stabilizers such as antioxidants.

The polymer may be coated using a variety of techniques of varying precision, many of which are known in the art, for example, knife coating, gravure coating, slide coating, spin coating, curtain coating, spray coating, die coating, etc. Viscosity of the polymer is important because it should be coatable to any desired thickness as described below. That is, low viscosity solutions of the polymer are needed for thin layers, and high viscosity solutions for thick layers. Other factors concerning coatability are disclosed in Humpal et al.

The laser ablatable layer is desirably under little or no stress, otherwise during ablation, it can undesirably change shape or dimension. Thus, if the polymer is to be coated and then hardened, the properties of the material in its liquid or precursor form are important. Any shrinkage during curing or cooling should preferably be matched to the rest of the laser ablatable article. These considerations may also determine the thickness of the laser ablatable layer, because stress is often built up during solvent coating and curing for layers having thicknesses of about 50 um or more. It is also desirable that the laser ablatable layer be cleanly ablatable with little or no generation of soot, not meltable under atmospheric pressure, and swell little under heat.

The surface of the laser ablatable layer which becomes the microstructured surface, referred to herein as the second surface, must have a roughness that is at least as good as that needed at the bottom of microstructured replicas that will be made from a microstructured tool having the laser ablatable layer. In general, the second surface may have an arithmetical mean roughness (Ra) of 1 um or less, and for most optical applications, Ra is 100 nm or less. The roughness of the second surface after ablation should be no more than these limits as well.

The thickness of the laser ablatable layer may vary depending on the application and, in general, the thickness provides a convenient mechanical limit to the depth of the one or more features comprising the microstructured surface. Suitable thicknesses may be up to about 1000 um. For some applications, thicknesses greater than about 1000 um could be used, although microstructured surfaces with feature depths greater than about 1000 um usually take longer to make, and it becomes increasingly difficult to control feature shape of the microstructured surface far from the image plane. It is desirable for the laser ablatable layer to have uniform thickness because this determines the height uniformity of the features in the microstructured layer. If the laser ablatable layer is too thick or is not uniform enough, it may be mechanically machined using grinding or fly cutting with a diamond cutting tool.

In order to prevent variations in the ablation rate, the laser ablatable layer is desirably uniform and homogeneous throughout with respect to absorptivity of the laser radiation, density, refractive index at the laser wavelength, etc. Under identical conditions, and with a laser power at least two times the ablation threshold, the ablation rate of the polymer should not vary more than 10% over the entire area of the laser ablatable article. As described below, the ablation threshold may be found by drawing a curve of ablation depth vs. pulse energy and extrapolating to zero depth.

As shown in FIG. 2a, microstructured tool 20 may comprise a tie layer 22 disposed between microstructured layer 14 and nickel layer 12 in order to promote adhesion between the two layers. The particular choice of components in the tie layer will depend on the materials used in the other layers. Examples of suitable materials include (meth)acrylates and primers such as Scotchprime® ceramo-metal primers available from 3M Company.

In general, the tie layer should be as thin as possible, for example, less than about 1 um, such that its mechanical properties do not substantially affect the ablation properties of the laser ablatable layer or the properties of the laser ablatable article either before or after ablation. If the roughness of any of the layers is critical as described above, then the tie layer must not increase the roughness.

Also, in such cases, the tie layer must not lower the damage threshold of the nickel layer, the laser fluence above which material is removed, the surface roughened, or the material distorted, to less than four times the fluence that it takes to ablate the laser ablatable layer. That is, the damage threshold of the nickel layer with the tie layer on it must be at least four times the fluence required to ablate the laser ablatable layer.

As shown in FIG. 2b, microstructured tool 24 may comprise adhesive layer 26 disposed between nickel layer 12 and base layer 18 in order to promote adhesion between the two layers. The particular choice of components in the adhesive layer will depend on the materials used in the other layers. Examples of suitable materials include metals such as zinc or chrome, and metal oxides such as chrome oxides. In one particular example, the adhesive layer comprises a zinc coating, less than about 1 um thick, disposed between a layer of electrolessly plated nickel and an aluminum base layer. If the nickel layer is first attached to the polymer and then to the base layer, it might be convenient to use an adhesive for the adhesive layer such as an epoxy, a urethane, or a pressure sensitive adhesive.

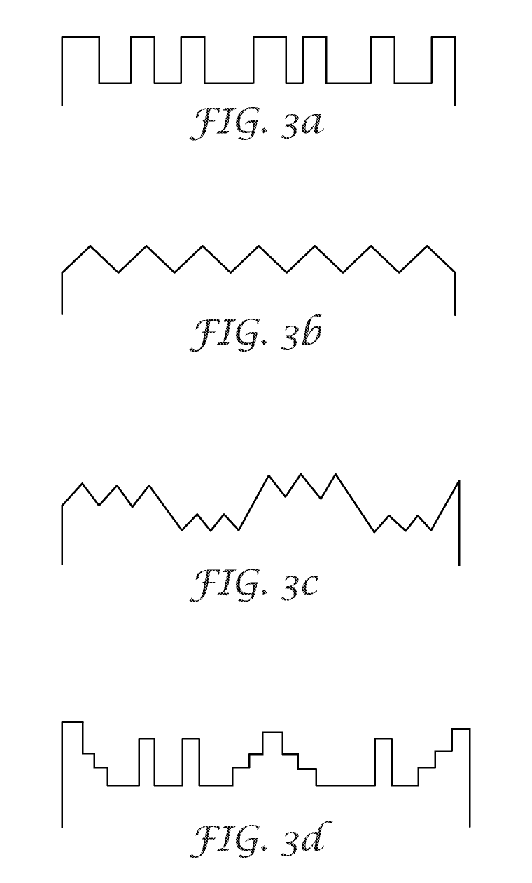

As shown in FIG. 1, microstructured layer 14 comprises microstructured surface 16. Microstructured surface refers to the three-dimensional topography of the surface that has been formed by removing portions of the laser ablatable layer using laser ablation. The schematic cross-sectional view of the microstructured surface shown in FIG. 1 is for illustration purposes only and is not intended to limit the microstructured surface in any way. FIGS. 3a-3d show cross-sectional views of additional exemplary microstructured surfaces.

The three-dimensional topography comprises one or more features that may very in terms of shape, size, and distribution across the surface. The features may be described as recesses, cavities, relief structures, microlens, grooves, channels, etc., and they may comprise rectangular, hexagonal, cubic, hemispherical, conical, pyramidal shapes, or combinations thereof.

As described above, the depth of the one or more features is limited by the thickness of the laser ablatable layer, such that they may have a maximum depth of up to about the maximum thickness of the laser ablatable layer. Thus, the one or more features may have a maximum depth of up to about 1000 um, for example, from about 0.5 um to about 1000 um. The one or more features may comprise multiple depths and the depths may vary from feature to feature if more than one feature is present. In some cases the nickel layer may be exposed within at least one of the recessive features. Dimensions other than the depth are not particularly limited.

If more than one feature is present, then they may be arranged in any way, such as randomly or in a pattern, or some combination thereof. For example, features may be randomly arranged within a region of the microstructured surface, and many regions may be arranged in a pattern across the surface. Examples of shape parameters that may be varied include depth, wall angle, diameter, aspect ratio (ratio of depth to width), etc.

Also disclosed herein is a method of making the microstructured tool. The method comprises providing a laser ablatable article comprising a laser ablatable layer comprising a polymer, a nickel layer comprising nickel, the nickel layer disposed adjacent the laser ablatable layer, and a base layer comprising metal, polymer, ceramic, or glass, the base layer disposed adjacent the nickel layer opposite the laser ablatable layer; providing a laser ablation apparatus having a laser; and ablating the laser ablatable layer with radiation from the laser to form a microstructured surface comprising one or more features.

As described above, any type of laser ablation apparatus or system may be used, provided it is equipped with a suitable laser and capable of multi-shot ablation. System parameters that may be varied include the wavelength of the radiation provided by the laser. Lasers that emit radiation having a wavelength of less than about 10 um are preferred because the feature size of the microstructured tool is limited by the wavelength of the laser. Also preferred are lasers that emit radiation having a wavelength of less than 2 um and less than 400 nm. The laser may be selected such that the radiation wavelength is less than about 10 times the resolution limit, i.e., the smallest dimension of a given feature to be ablated, and more preferably, less than 5 times the resolution limit, and most preferably, less than 2 times the resolution limit. More important is that the laser ablatable material have a high absorption at the wavelength used.

For efficiency, it is often desirable to select the laser depending on the absorption of the laser ablatable layer, or vice versa. The laser ablatable layer ideally has an absorption coefficient greater than about 1×10³ per cm at the wavelength of the radiation provided by the laser. This helps minimize the ablation threshold, allowing structures to be created at lower powers. This also helps limit the collateral damage of the ablation process and allows smaller features to be made.

Other system parameters may be selected by determining the threshold energy density of the laser ablatable layer, which is the amount of laser energy necessary to ablate the least bit of the ablatable layer. The ablation threshold is found by drawing a curve of ablation depth vs. pulse energy and extrapolating to zero depth. One parameter that may be varied is the energy of the laser pulse. Varying the laser pulse energy is a convenient way of varying the depth of material removed at each pulse of the laser. Higher energies will remove more material, increasing productivity. Lower pulse energies will remove less material, increasing control of the process. It is desirable that the ablatable material have no process memory; that is, for the same laser pulse parameters, in each pulse, the same amount of material is removed no matter how many preceeding pulses. The depth of the features can then be controlled by knowing the depth per pulse and counting the number of pulses. Pulse width, temporal pulse shape, wavelength, and coherence lengths of the laser also affect the ablation process, but these parameters are usually fixed in each laser or can be varied only a small amount. The thickness of the laser ablatable layer is another factor to consider. As described above, the thickness before ablation needs to be at least that required for the maximum height of the microstructured surface, and multiple depths may also be desired, as well as removal of the laser ablatable layer down to the nickel layer.

In some cases, such as when enough pulses are used to ablate the laser ablatable layer down to the surface of the nickel, it may be desirable for the polymer to have a laser ablation threshold, the nickel layer a laser damage threshold, and wherein the laser ablation threshold is less than 0.25 of the laser damage threshold. This difference helps to ensure a clean, flat bottom of the microstructured layer without affecting the nickel layer.

The shapes of the laser ablatable article and the microstructured tool made therefrom are not particularly limited except that the laser ablation system must be able to define an image plane during ablation. The shapes either before, during, or after ablation may be the same or different. For example, both the laser ablatable article and the microstructured tool may be in a generally flat, sheet-like form, or the laser ablatable article may be in a generally flat, sheet-like form, and after ablation, be formed into a cylinder or a belt. Alternatively, the laser ablatable article may be in the shape of a cylinder or belt before ablation.

The microstructured tool may comprise an additional layer on the microstructured surface for protection against chemical degradation or mechanical damage, or to change the surface energy or optical characteristics. In particular, diamond-like glass may be applied using a plasma deposition process in order to make microstructured thin films that may be used in a variety of applications; see U.S. Pat. No. 6,696,157 B1 for a description of diamond-like glass and its applications.

The microstructured tool may undergo further processing, packaging, integration, or be cut into smaller parts.

Also disclosed herein is a method of making a microstructured replica, the method comprising: providing a microstructured tool as described above; applying a liquid composition over the microstructured surface; hardening the liquid composition to form a hardened layer; and separating the hardened layer from the microstructured tool. Before applying the liquid composition, the microstructured surface may be treated with a release agent such as a fluorochemical-, silicone-, or hydrocarbon-containing material. The liquid composition may comprise one or more monomers, oligomers and/or polymers that are hardening by curing, or molten polymer that is hardened by cooling. In either case, the microstructured tool may be used repeatedly to make any number of microstructured replicas.

Also disclosed herein is a method of making a microstructured metal tool, the method comprising: providing the microstructured tool as described above; applying a metal over the microstructured surface to form a metal layer; and separating the metal layer from the microstructured tool. The metal may be electroplated onto the microstructured surface. Before applying the metal, the microstructured surface may be coated with a conductive seed layer for metal deposition during the electroplating process. The conductive seed layer may be applied using a vapor deposition process. FIG. 6 is a photograph of an exemplary microstuctured metal tool. The resulting microstructured metal tool may be used repeatedly to make any number of microstructured replicas. The microstructured metal tool may be used to make metal replicas or polymeric replicas. Either replica or the microstructured metal tool may be used to make an article. For example, the article may comprise a microstructured layer of frit formed on a glass substrate which is then heated to form a barrier rib structure for a plasma display device as described in U.S. Pat. No. 6,802,754, the disclosure of which is incorporated herein by reference.

### EXAMPLES

### Example 1

A commercially available aluminum sheet material (from Lorin Industries) with a thickness of 508 um (0.020″) was ablated using an excimer laser ablation system comprising a Lambda Physik laser LPX 315. The laser beam was homogenized and passed through a mask that was imaged with a 5× projection lens using an optic system by Microlas. A total of 90 shots at a beam fluence of 862 mJ/cm² and 150 pulses per second were used. Before and after ablation, the root mean square (RMS) roughness and the arithmetical mean roughness (Ra) were measured. Results are reported in Table 1.

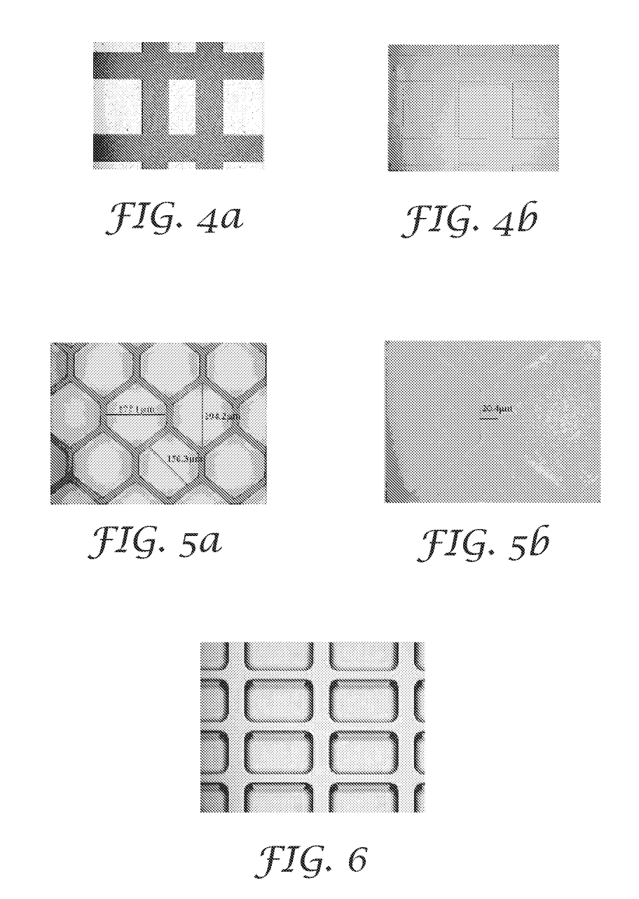

The aluminum sheet material described above was plated with a layer of electroless nickel having a thickness of 2.5-7.6 um (0.0001-0.0003″). The plating process was carried out at Twin City Plating of Minneapolis, Minn. The sample was ablated as described above. RMS and Ra are reported in Table 1. FIGS. 4a and 4b show photographs of aluminum and nickel plated aluminum, respectively, after ablation. The dark region in FIG. 4a is roughened aluminum which scatters light considerably, compared to the specularly reflective surface of the nickel plated aluminum shown in FIG. 4b.

TABLE 1

| | |
|---|---|
| Aluminum | e-Nickel Aluminum |

| | Ablated | Unablated | Ablated | Unablated |
|---|---|---|---|---|
| RMS (um) | 0.266 | 0.089 | 0.029 | 0.024 |
| Ra (um) | 0.206 | 0.035 | 0.022 | 0.019 |

### Example 2

A commercially available aluminum sheet material (PREMIRROR 41 from Lorin Industries) with a thickness of 508 um (0.020″) was plated with a layer of electroless nickel. The layer of electroless nickel was 2.5-7.6 um (0.0001-0.0003″) thick. The plating process was carried out at Twin City Plating of Minneapolis, Minn.

The electroless nickel surface was cleaned with ethyl alcohol and a cloth wipe. To the surface was then applied a solution of Scotchprime® 389 ceramo-metal primer available from the 3M Company. The solution was sprayed onto the nickel surface, wiped to achieve a uniform coating, allowed to air dry, and cured in an oven at 110° C. for 10 minutes. The panel was removed and cooled to room temperature and any remaining unreacted agent removed with EtOH and a cloth wipe.

A urethane acrylate resin was prepared by mixing prepolymer components of an aromatic urethane triacrylate with 40 wt. % ethoxylated trimethylolpropane triacrylate as diluent (EBECRYL 6602 from Cytec Surface Specialties) at 82.5 wt. %, an ethoxylated trimethylolpropane triacrylate (SARTOMER SR454 from Sartomer Co.) at 16.5 wt. %, and photoinitiator (IRGACURE 369 from Ciba Specialty Chemicals) at 1 wt. %. The resin was coated over the nickel surface to a thickness of between 155-225 um by one of the following two methods: 1) A precision die coater at elevated temperature (i.e., 65° C.) providing a coating uniformity of ±5 um. 2) A standard knife coater at room temperature providing a coating uniformity of ±15 um. If the latter coating process is used, the sample may then be made more uniform by planarizing the top surface after curing by conventional machining methods such as flycutting, grinding, or lapping.

The coated panel was enclosed within a metal framed, glass topped, “inerting” chamber. The chamber was purged with dry nitrogen for 1 minute to reduce the oxygen level. The sample was then cured with UV radiation (15 W, 18″-blacklight-blue bulbs, 30 seconds, 320-400 nm, ˜5-25 mW/cm²).

The resulting laser ablatable article was ablated as described in Example 1. The pattern ablated into the coated panel was a hexagonal array of hexagons. The resulting microstructured tool had a thickness of 162 μm and the pattern was ablated through to the nickel layer. The ablation debris was removed using ethyl alcohol and gentle wiping with a flock pad. FIGS. 5a and 5b show photographs of the ablated panel at about 100× and 500× magnification, respectively. The pattern is a hex-Delta pattern wherein the darker areas correspond to the non-ablated regions (polymer), and the lighter areas the ablated regions. Each hexagon has dimensions 172.1, 194.2, and 156.3 um as shown in FIG. 5a, and the width of the non-ablated regions is 20.4 um as shown in FIG. 5b.

### Example 3

A microstructured tool was prepared as described in Example 2, except that a standard waffle pattern was ablated into the coated panel instead of the hexagonal array of hexagons. A metal layer comprising nickel, about 1 mm (40 mil) thick, was electroformed onto the microstructured tool (over the microstructured polymeric layer) using standard electroform protocol. A microstructured metal tool was then prepared by separating the metal layer from the microstructured tool, and residual polymer was removed from the microstructured metal tool with aqueous base (50:50, KOH:water) at 90-99° C.

### Microstructured Replicas

Microstructured replicas could be made using tools such as the ones described in Examples 2 and 3. This would be carried out by treating the microstructured surface of the tool with a release agent and then coating a composition comprising one or more curable species such as a monomer, oligomer, polymer, crosslinker, etc., or some combination thereof. The composition could then be cured to form a cured layer which could then be separated from the tool.

Various modifications and alterations of this invention will be apparent to those skilled in the art without departing from the scope and spirit of the invention, and it should be understood that this invention is not limited to the examples and embodiments described herein.

What is claimed is:

1. A microstructured tool comprising:
a microstructured layer comprising a polymer and having a microstructured surface, the microstructured surface comprising one or more features;
a nickel layer comprising nickel, the nickel layer disposed adjacent the microstructured layer opposite the microstructured surface; and
a base layer comprising metal, polymer, ceramic, or glass, the base layer disposed adjacent the nickel layer opposite the microstructured layer.

2. The microstructured tool of claim 1, the base layer comprising aluminum.

3. The microstructured tool of claim 1, the base layer having an area greater than about 100 cm² and a flatness better than 10 um per 100 cm².

4. The microstructured tool of claim 1, the base layer having an area greater than about 100 cm² and a parallelism better than 10 um per 100 cm².

5. The microstructured tool of claim 1, the nickel layer consisting essentially of nickel.

6. The microstructured tool of claim 1, the nickel layer having a thickness of from about 0.5 um to about 2 cm.

7. The microstructured tool of claim 1, the nickel layer having a first surface adjacent the microstructured layer, the first surface having an arithmetical mean roughness (Ra) of 100 nm or less.

8. The microstructured tool of claim 1, wherein the nickel layer is formed on the base layer by an electrochemical process, sputtering, chemical vapor deposition, or physical vapor deposition.

9. The microstructured tool of claim 1, wherein the polymer comprises polycarbonate, polystyrene, polyurethane, polysulfone, polyimide, polyamide, polyester, polyether, phenolic, epoxy, (meth)acrylics, or combinations thereof.

10. The microstructured tool of claim 1, wherein the polymer is formed from one or more monomers, oligomers and/or polymers that have been cured using UV radiation.

11. The microstructured tool of claim 1, wherein at least one of the one or more features has a maximum depth of from about 0.5 um to about 1000 um.

12. The microstructured tool of claim 1, the one or more features comprising rectangular, hexagonal, cubic, hemispherical, conical, pyramidal shapes, or combinations thereof.

13. The microstructured tool of claim 1, further comprising a tie layer disposed between the microstructured layer and the nickel layer.

14. The microstructured tool of claim 1, further comprising an adhesive layer disposed between the nickel layer and the base layer.

15. The microstructured tool of claim 1, wherein the microstructured tool is shaped as a cylinder, a flat, or a belt.

16. A method of making a microstructured tool, the method comprising:
providing a laser ablatable article comprising:
a laser ablatable layer comprising a polymer,
a nickel layer comprising nickel, the nickel layer disposed adjacent the laser ablatable layer, and
a base layer comprising metal, polymer, ceramic, or glass, the base layer disposed adjacent the nickel layer opposite the laser ablatable layer;
providing a laser ablation apparatus having a laser; and
ablating the laser ablatable layer with radiation from the laser to form a microstructured surface comprising one or more features.

17. The method of claim 16, the radiation having a wavelength of less than about 2 um.

18. The method of claim 16, the radiation having a wavelength of less than about 400 nm.

19. The method of claim 16, the radiation having a wavelength less than about two times the smallest dimension of the one or more features.

20. The method of claim 16, the base layer comprising aluminum.

21. The method of claim 16, the laser ablatable layer having an absorption coefficient greater than about 1×10³ per cm at the wavelength of the radiation.

22. The method of claim 16, the polymer having a laser ablation threshold, the nickel layer having a laser damage threshold, wherein the laser ablation threshhold is less than 0.25 of the laser damage threshold.

23. The method of claim 16, wherein the laser ablatable layer is not meltable under atmospheric pressure.

24. The method of claim 16, wherein the laser ablatable article is shaped as a cylinder, flat, or belt.

25. The microstructured tool formed by the method of claim 16.

26. A method of making a microstructured replica, the method comprising:
providing the microstructured tool of claim 1;
applying a liquid composition over the microstructured surface;
hardening the liquid composition to form a hardened layer; and
separating the hardened layer from the microstructured tool.

27. The method of claim 26, the liquid composition comprising one or more monomers, oligomers and/or polymers, and hardening comprising curing.

28. The method of claim 26, the liquid composition comprising one or more molten polymers, and hardening comprising cooling.

29. The microstructured replica prepared by the method of claim 27.

30. A method of making a microstructured metal tool, the method comprising:
providing the microstructured tool of claim 1;
applying a metal over the microstructured surface to form a metal layer; and
separating the metal layer from the microstructured tool.

31. The microstructured metal tool prepared by the method of claim 30.

32. A barrier rib structure prepared from the microstructured metal tool of claim 30.

33. A plasma display device comprising the barrier rib structure of claim 32.
